(19) United States
(12) Patent Application Publication
(10) Pub. No.: US 2012/0111929 A1
(43) Pub. Date: May 10, 2012

(54) SOLDER ROD, SOLDERING OF HOLES, COATING PROCESS

(76) Inventors: Francis-Jurjen Ladru, Berlin (DE); Gerhard Reich, Berlin (DE); Adrian Wollnik, Berlin (DE)

(21) Appl. No.: 13/379,521

(22) PCT Filed: Jun. 26, 2009
(86) PCT No.: PCT/EP09/04646

§ 371 Date: Dec. 20, 2011

(51) Int. Cl. B23K 1/00; B21D 39/00; B32B 15/01

(52) U.S. Cl. 228/246; 428/615; 428/621; 428/668; 428/680

(57) ABSTRACT

A metallic solder rod is provided. The solder rod includes a stop-off at the end so that the solder cannot drip from an opening. The solder rod includes an inner region and an outer region which at least partially surrounds the inner region wherein the inner region includes a different alloy than the outer region. A process for applying solder to a hole in a substrate is also provided.

### CROSS REFERENCE TO RELATED APPLICATIONS

This application is the US National Stage of International Application No. PCT/EP2009/004646, filed Jun. 26, 2009 and claims the benefit thereof. All of the applications are incorporated by reference herein in their entirety.

### FIELD OF INVENTION

The invention relates to solder rods, to the soldering of holes and to processes for coating components having holes.

### BACKGROUND OF INVENTION

Components often have holes that need to be closed off. In the case of turbine blades or vanes, these holes are cooling-air holes. These components are then often recoated and again provided with cooling-air holes.

The recoating of components having cooling-air holes frequently gives rise to the problem of “coat down” and the removal thereof.

### SUMMARY OF INVENTION

It is therefore an object of the invention to specify the soldering of holes, in particular cooling-air holes, and a process for coating components having holes and solder rods which solve the above-mentioned problem.

The object is achieved by a solder rod as claimed in the claims, by a soldering process as claimed in the claims and by a coating process as claimed in the claims.

The dependent claims each list further measures which can be combined with one another as desired to obtain further advantages.

### BRIEF DESCRIPTION OF THE DRAWINGS

In the drawings:

FIGS. 1 to 5 show a process for coating components having holes,

FIGS. 6, 7, 12-14 show processes for soldering holes,

FIGS. 8-11 show solder rods,

FIG. 15 shows a gas turbine,

FIG. 16 is a perspective view of a turbine blade or vane,

FIG. 17 is a perspective view of a combustion chamber,

FIG. 18 is a list of superalloys.

The figures and the description merely represent exemplary embodiments of the invention.

### DETAILED DESCRIPTION OF INVENTION

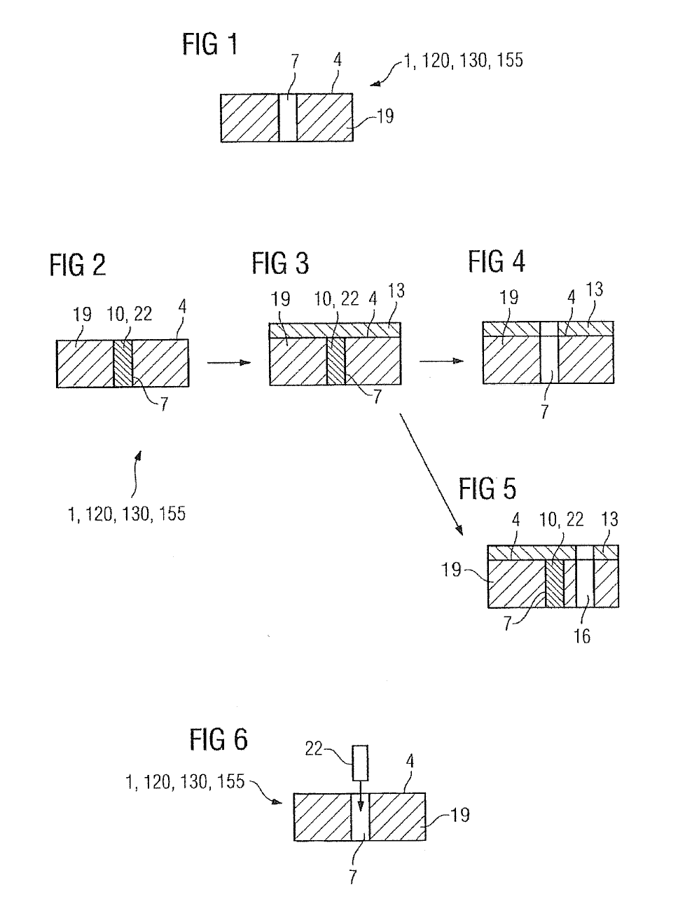

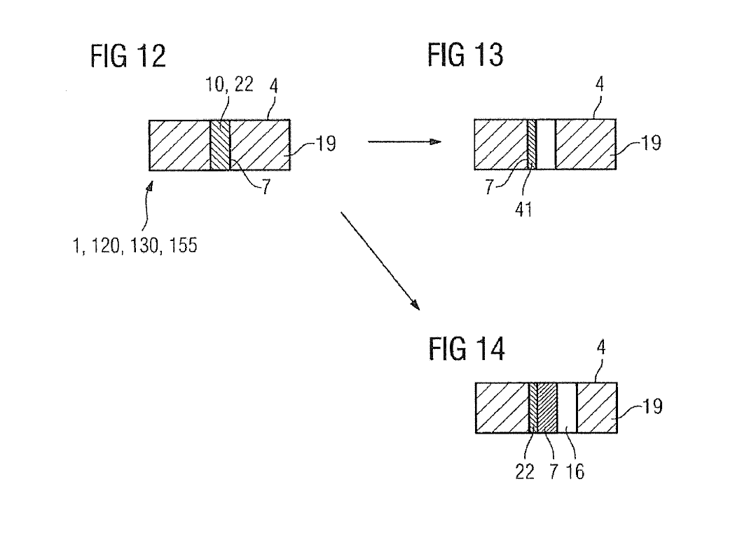

FIG. 1 shows a component 1, 120, 130, 155 (FIGS. 12, 13, 14) having a continuous hole 7, where a surface 4 of the substrate 19 of the component 1, 120, 130, 155 is preferably to be recoated.

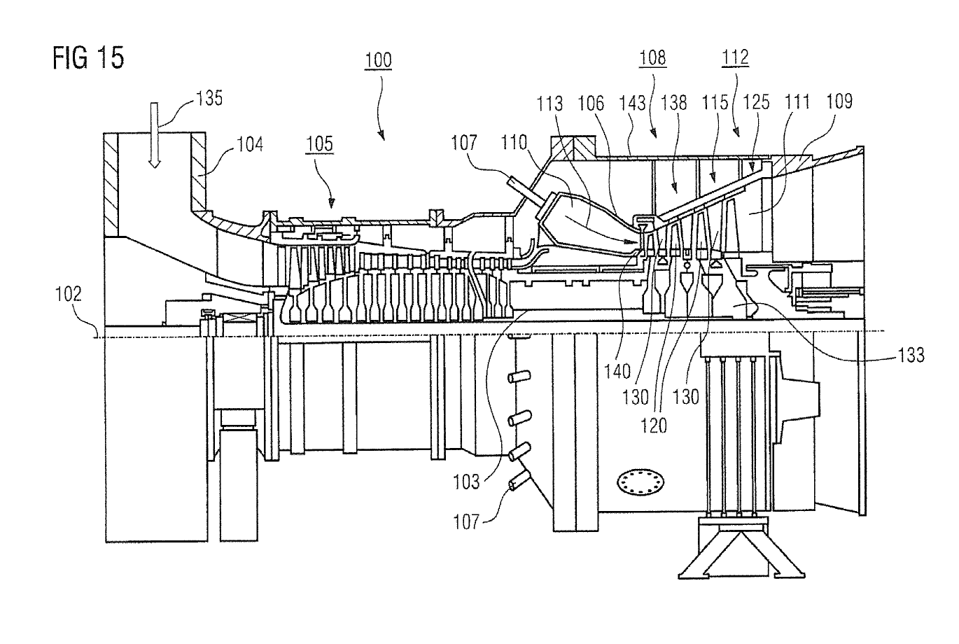

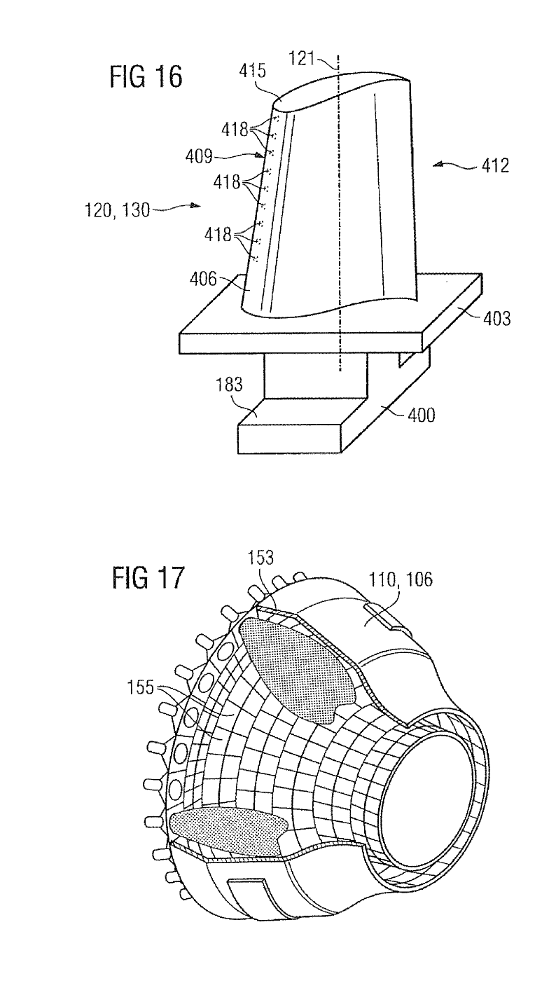

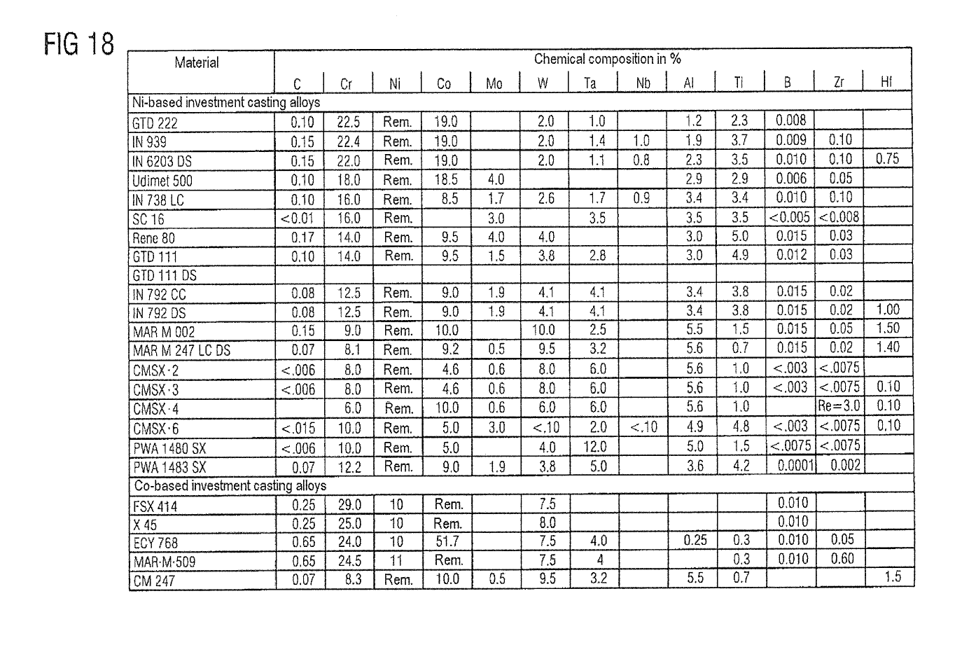

The substrate 19 of the component 1, 120, 130, 155 is preferably metallic and preferably comprises a superalloy as per FIG. 18. These are used, in particular, for components 1, 120, 130, 155 for gas turbines 100 (FIG. 15), e.g. turbine blades or vanes 120, 130 (FIG. 16).

In FIG. 2, in a first step, a solder 10 is introduced into the hole 7, in particular a cooling-air hole 7.

In a further process step, a coating 13 is applied to the surface 4 of the substrate 19 (FIG. 3). Since the solder 10 fills the hole 7, the coating 13 is also present over the solder 10.

Particularly in the case of turbine blades or vanes 120, 130, the coating 13 is a metallic bonding layer, in particular an MCrAlX alloy, on which an outer ceramic layer (not shown) is also preferably applied.

Similarly, in the arrangement shown in FIG. 2, a metallic protective layer can also be present on the surface 4 of the substrate 19, the solder 10 then being present both in the substrate 19 and in said metallic protective layer, which surrounds the hole 7.

Since, however, the coated component 120, 130, 155 should in turn have holes 16, in particular cooling-air holes, a new hole 16 is made at another point, i.e. where the hole 7 closed by solder 10 is not located (FIG. 5).

This is not always possible, and therefore, as shown in FIG. 4, the hole 7 is reopened at that point where the solder 10 was present, such that the component 1, 120, 130, 155 again has a cooling-air hole 16 at the site of the hole 7.

The complete filling with solder 10, 22 and reopening prevent the “coat down” and entail advantages even if all the solder has to be removed again. EDM processes are suitable here.

The process according to FIGS. 2 to 5 can also be carried out as an intermediate step without coating processes. This is shown in FIGS. 12, 13 and 14.

Here, a treatment is carried out between FIG. 12 and FIGS. 13, 14 in which the cooling holes have to be closed. In this case, it is possible, depending on new requirements, for only part of the solder rod to be removed. A remnant 41 of the solder rod thus remains in the region 10 of the new film-cooling hole 16.

FIG. 6 shows a process for soldering a substrate 19 having a hole 7 in very general terms.

The solder 10 here is introduced in the form of a solder rod 22, the external diameter/external cross section of the solder rod 22, which preferably has a wire or rod foam, being the same as the internal diameter/internal cross section of the hole 7.

To completely solder the hole 7, it is therefore necessary to heat, in particular locally, only the solder rod 22, and the hole 7 is closed completely and uniformly. The volume of the solder rod 22 preferably corresponds to the volume of the hole 7. If more solder is used, or solder 10 protrudes over the surface 4, it can be removed.

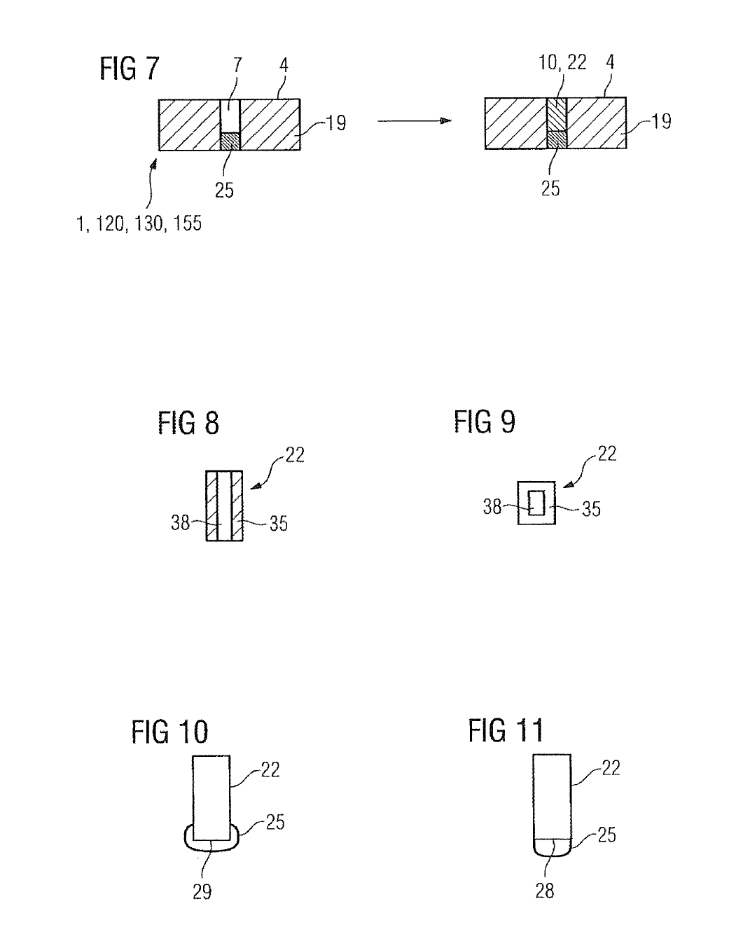

FIG. 8 shows a solder rod 22 having two regions, an inner region 38 and an outer region 35.

The inner region 38 (core) preferably comprises a nickel-based superalloy, preferably like the substrate 19, very preferably according to FIG. 18. The core consists in particular of a superalloy, in particular according to FIG. 18.

In any case, the inner region 38 does not melt at the soldering temperatures of the soldering process (FIGS. 2-5, 7, 12, 13, 14).

The outer region 35 comprises an alloy which melts at the soldering temperatures of the soldering process (FIGS. 2, 7), i.e. said alloy differs from the alloy of the inner region 38.

The composition of the outer region 35 differs from the composition of the core 38. It preferably represents a solder alloy comprising melting point reducers such as boron or silicon. It is preferable that melting point reducers were added proceeding from the same composition as that of the core 38. Only one melting point reducer is present, in particular.

It is likewise preferable for it to have a composition without melting point reducers such as boron or silicon, which has a lower melting temperature than the core 38. This can be a modified alloy—preferably comprising the same elements—of the core 38 with increased or lowered proportions, preferably of aluminum and/or titanium and/or tantalum, which lower the melting point.

The outer region 35 can represent an overlay layer. It is preferable that the core 38 has also been inserted into a sleeve made of a solder alloy 35.

It is likewise preferable for the outer region 35 to also represent a diffusion layer, and the outer region 35 has preferably been produced by the diffusion of at least one melting point reducer (preferably B, Si).

It is also possible for there to be a combination of diffusion and overlay layers here.

The outer region 35 at least partially surrounds the inner region 38.

The outer region 35 is preferably present only in the lateral region, but can also cover the end faces (FIG. 9).

Both the inner region 38 and the outer region 35 can represent nickel-based or cobalt-based superalloys.

In order to prevent the solder 10 from flowing or dripping into a hollow space during soldering, e.g. in the case of a cooling-air hole of a turbine blade or vane 120, 130, the solder rod 22 has a stop-off 25 at the end 29 (FIGS. 10, 11), and this stop-off prevents solder 10 of the solder rod 22 from dripping out of the hole 7 or into the hollow space.

The stop-off 25 preferably wets the solder rod 22. The stop-off can comprise a ceramic or an alloy. In any case, the stop-off 25 is made from a material that differs from the material of the solder rod 22. Use is preferably made of an alloy. Use is similarly preferably made of oxide ceramics, very preferably spinels, perovskites, pyrochlores, more particularly zirconium oxide, aluminum oxide or mixtures thereof. For this purpose, stop-offs known from the prior art can be used.

The stop-off 25 can be applied in the form of a foil, slip, paste etc. Use is preferably made of a paste.

The stop-off 25 is preferably present only on the end face 28 of the rod 22 and wire 22 (FIG. 9).

Rods 22 of this type, as shown in FIGS. 8, 9, can also be used in the process shown in FIG. 1 to FIG. 6.

Similarly, it is possible for the stop-off 25 to firstly be introduced into the hole 7, and the solder 10, preferably the rod 22, is then introduced into the hole 7 (FIG. 7).

FIG. 15 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113.

From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure). By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 It is also possible for a thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

It is also possible for a thermal barrier coating to be present on the MCrAlX, consisting for example of ZrO2, Y2O3-ZrO2, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 16 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8A1-0.6Y-0.7Si or Co-28Ni-24Cr-10A1-0.6Y. In addition to these cobalt-based protective coatings, it is also preferable to use nickel-based protective layers, such as Ni-10Cr-12A1-0.6Y-3Re or Ni-12Co-21Cr-11A1-0.4Y-2Re or Ni-25Co-17Cr-10A1-0.4Y-1.5Re.

It is also possible for a thermal barrier coating, which is preferably the outermost layer, to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

The thermal barrier coating covers the entire MCrAlX layer. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrA1X layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 17 shows a combustion chamber 110 of a gas turbine.

The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example ceramic, thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

1-23. (canceled)

24. A metallic solder rod, comprising:
an inner region; and
an outer region,
wherein the outer region at least partially surrounds the inner region, and
wherein the inner region comprises a different alloy than the outer region.

25. The solder rod as claimed in claim 24, wherein the solder rod includes a wire or rod form.

26. The solder rod as claimed in claim 24,
wherein the solder rod includes a stop-off at the end thereof, and
wherein the end is wetted therewith.

27. The solder rod as claimed in claim 26, wherein the stop-off comprises a ceramic.

28. The solder rod as claimed in claim 26,
wherein the stop-off comprises a first alloy which differs from a second and/or third alloy of the inner and outer regions, respectfully.

29. The solder rod as claimed in claim 28,
wherein the third alloy of the outer region includes a lower melting temperature than the second alloy of the inner region, and
wherein the lower melting temperature of the outer region is lower by 10° C.

30. The solder rod as claimed in claim 24, wherein the outer region of the solder rod represents a covering coating.

31. The solder rod as claimed in claim 24,
wherein the outer region represents a diffusion layer, which has been produced by the diffusion of a melting point reducer.

32. The solder rod as claimed in claim 24, wherein the outer region only partially surrounds the lateral surface of the inner region.

33. The solder rod as claimed in claim 24, wherein the inner region comprises a cobalt-based or nickel-based superalloy.

34. The solder rod as claimed in claim 24, wherein the outer region comprises a cobalt-based or nickel-based superalloy.

35. The metallic solder rod as claimed in claim 24, wherein a first material of the inner region corresponds to a second material of the substrate.

36. A process for applying solder to a hole in a substrate, comprising:
providing the solder in the form of a wire or a rod; and
introducing the solder rod into a hole before a coating is applied to the substrate,
wherein the solder rod comprises an inner region and an outer region,
wherein the outer region at least partially surrounds the inner region,
wherein the inner region comprises a different alloy than the outer region.

37. The process as claimed in claim 36, wherein a melting temperature of a first alloy of the outer region is exceeded during the soldering.

38. The process as claimed in claim 36, wherein a hole is made in a coated component where no solder is present.

39. The process as claimed in claim 36, wherein a hole is made in a coated component at that point where a solder was previously introduced, which has been largely, ≧90%, removed.

40. The process as claimed in claim 36, wherein a hole is made in a component with only a part of the solder rod being removed, such that a remnant of the solder rod remains in the film-cooling hole.

41. The process as claimed in claim 36, wherein an external diameter or cross section of the solder rod corresponds to an internal diameter or an internal cross section of the hole.

42. The process as claimed in claim 36, wherein first a stop-off and then the solder are introduced into the hole.

43. The process as claimed in claim 36, wherein a first material of the outer region differs from a second material of the substrate and includes a lower melting temperature than an alloy of the substrate wherein the melting temperature is lower by 10° C.
